(19) United States
(12) Patent Application Publication
(10) Pub. No.: US 2005/0041846 A1
(43) Pub. Date: Feb. 24, 2005

(54) Document counterfeit protection mechanism

(76) Inventor: Shih Ping Chen, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/642,727

(22) Filed: Aug. 19, 2003

(51) Int. Cl. G06K 9/00; G06K 19/00

(52) U.S. Cl. 382/135; 235/487

(57) ABSTRACT

A document counterfeit protection mechanism is provided. The counterfeit protection mechanism provides a counterfeit protection image, providing an optical encoding function for encoding the counterfeit protection image and providing an optical curve body and a base beneath the optical curve body. The base and the optical curve body are monolithically formed together, for having the encoded counterfeit protection image distributed on the base, and an optical decoding function incorporating with the optical curve body is provided for decoding the encoded counterfeit protection image on the base. The optical decoding function is an inverse function of the optical encoding function.

### BACKGROUND OF THE INVENTION

1. Field of the Invention

The present invention relates to a document counterfeit protection mechanism, and, more particularly, to a document counterfeit protection mechanism providing an optical decoding piece, encoding the original counterfeit protection image with an optical function, which is an inverse function of the equivalent optical function of the optical decoding piece, and placing the encoded counterfeit protection image on a base monolithically formed on an optical curve body. Thereby, placing the optical decoding piece at a predetermined region of the base enables the display of the original counterfeit protection image, in order to prove the genuineness of the document.

2. Description of the Prior Art

As many digital image-processing systems, such as a digital color copier, are able to produce high quality documents at comparatively very low cost, some people take advantage of these systems for the illegal copying of, for example, cash, checks, stock certificates with ease.

Meanwhile, current document counterfeit protection technologies focus on placing sophisticated counterfeit protection images on documents, causing the average person great confusion in discerning fake from genuine documents. Moreover, counterfeiter need only to use increasingly sophisticated optical instruments, such as scanners, for copying the counterfeit protection images or even entire documents to render the fake and genuine documents nearly indistinguishable. Even if a given document does not to employ the aforementioned printed counterfeit protection image but rather a laser film made by laser full-image technology, persons with ordinary skill in this art are still able to reproduce documents that are not visually distinguishable, without permission. Furthermore, with no effective device or method to detect document counterfeiting and illegal copying, these fake, unauthorized documents inevitably pose at least some sort of negative impact on the whole market.

Reference is made to FIG. 1 of a document counterfeit protection mechanism 50 based on the prior art. The counterfeit protection mechanism 50 includes steps as follows:
Step 52: prepare a counterfeit protection image 53;
Step 54: encode counterfeit protection image 53 through an optical encoding function, wherein all images, including this counterfeit protection image 53, are represented by the distribution of pixels and RGB values of these pixels (from 0 to 255);
Step 56: generate a corresponding outcome from encoding Step 54;
Step 58: decode the encoded counterfeit protection image 53 through another optical function substantially equal to an inverse function of the optical encoding function used in Step 54; and
Step 59: restore the original counterfeit protection image 53.

No matter how complex the optical encoding functions are, people with intensions to copy documents without permission need not understand every detail of the optical encoding function, but only need to copy the restored counterfeit protection image 53 and the major image (not shown) from Step 59 directly through optical instruments to illegally copy documents. Therefore, the counterfeit protection mechanism 59 according to the prior art does not effectively avoid any potential illegal document copying from happening.

### SUMMARY OF THE INVENTION

It is therefore a primary objective of the present invention to provide a counterfeit protection mechanism incorporating an optical curve body with a monolithically formed base. The counterfeit protection image is still encoded by an optical encoding function, and the outcome of the encoding is distributed on the base. Additionally, the current counterfeit protection mechanism requires an optical decoding piece having an optical function, which is an inverse function of the optical encoding function, and therefore, the counterfeit protection image, which has been encoded and distributed on the base, will be restored back into its original form with the use of the optical decoding piece. Given the fact that the original counterfeit protection image has been encoded and placed under an optical curve body (preferably, a semi-cylindrical lens array), it cannot be copied directly through commonly used optical instruments, thereby curbing the occurrences of document counterfeiting.

In accordance with the claimed invention, a document anti-counterfeiting mechanism includes providing an optical curve body and a base disposed under the optical curve body in order to form a one-piece main body of the document. An optical decoding piece substantially equivalent to a first optical function is provided for confirming the genuineness of the document when the counterfeit protection image has been searched through the incorporation of the optical curve body and the optical decoding piece. A second optical function is derived from the first optical function. The second optical function is an inverse function of the first optical function. The counterfeit protection image is processed through the second optical function in order to generate a corresponding post-processing counterfeit protection image. The post-processing counterfeit protection image is then placed on the base. The counterfeit protection image is then displayed through the use of the optical decoding piece.

It is an advantage of the present invention that the encoded counterfeit protection image is placed under the optical curve body, to make reproduction of the encoded counterfeit protection image difficult, and further places an optical decoding piece with an optical decoding function, which is an inverse function of the encoding function for the original (before encoding) counterfeit protection image, at a predetermined region with a predetermined side thereof and a predetermined angle, in order to search for the existence of the original counterfeit protection image and confirmed the genuineness of this document. In summary, the present invention provides a counterfeit protection mechanism having the encoded counterfeit protection image placed under an optical curve body and further with the use of an optical decoding piece in order to have the original counterfeit protection image displayed at a predetermined region for confirming the genuineness of the document.

### BRIEF DESCRIPTION OF THE DRAWINGS

These and other objectives of the present invention will no doubt become obvious to those of ordinary skill in the art after reading the following detailed description of the preferred embodiment that is illustrated in the various figures and drawings, wherein:

FIG. 1 is a simplified flow chart of a document counterfeit protection mechanism based on the prior art;

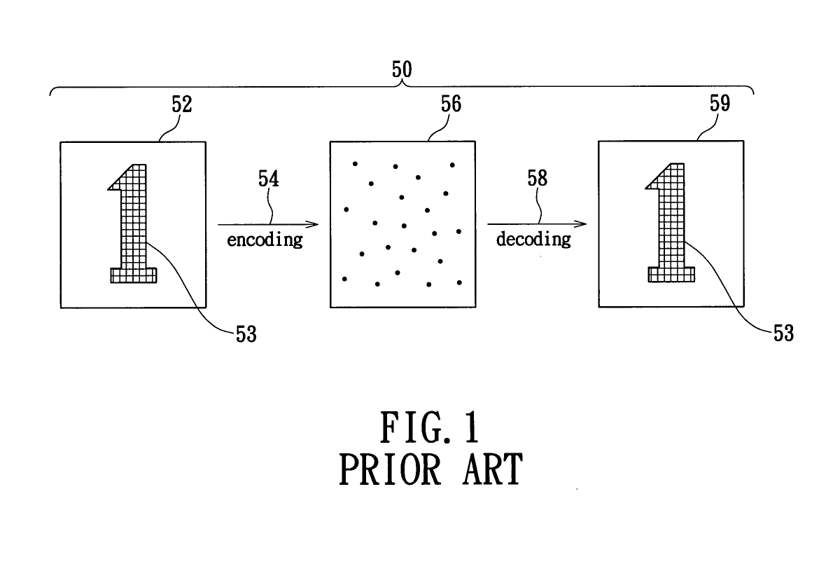

FIG. 2 is a flow chart illustrating a document counterfeit protection mechanism according to the present invention;

FIGS. 3A to 3C are schematic diagrams showing the marking distribution of the optical decoding piece;

FIG. 4 is a schematic diagram of showing a document with the counterfeit protection mechanism based on the present invention; and

FIG. 5 is a simplified flow chart showing a document counterfeit protection mechanism according to the present invention.

### DETAILED DESCRIPTION OF THE PREFERRED EMBODIMENT

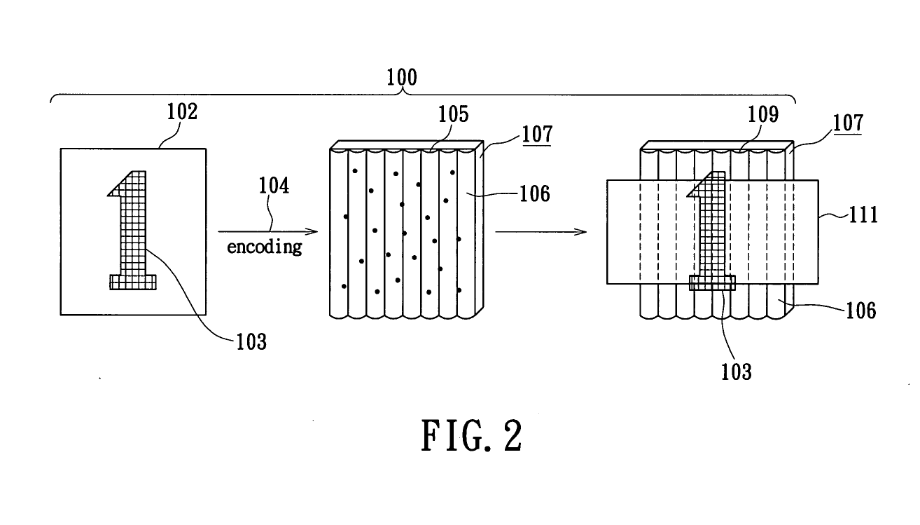

Reference is made to FIG. 2, which is a flow chart illustrating a document counterfeit protection mechanism 100 according to the present invention. The counterfeit protection mechanism 100 includes steps as follows:
Step 102: provide a counterfeit protection image 103;
Step 104: encode the counterfeit protection image 103;
Step 105: have the encoded counterfeit protection image distributed on a base 107 under an optical curve body, wherein the base and the optical curve body are monolithically formed together; and
Step 109: provide an optical decoding piece 111 for looking for the original counterfeit protection image 103 through the optical decoding piece 111 and the optical curve body at a predetermined region.

The optical decoding piece is substantially equivalent to a first optical function. In the counterfeit protection mechanism 100, the characteristics of the optical decoding piece will be determined in advance. Upon the characteristics of the optical decoding piece is determined, the encoding optical function (second optical function) can be derived from the first optical function, through inverse function calculation. Thereafter, the second optical function serves to encode the original counterfeit protection image, so as to generate a corresponding post-encoding counterfeit protection image on the base of the main body of this document, as shown in Step 105. The encoded counterfeit protection image will be placed in a predetermined region on the base 107 under the optical curve body 106.

However, the optical curve body is substantially equal to a third optical function; thus, the original counterfeit protection image 103 will be converted through the encoding of the second optical function and the third optical function of the optical curve body 106, theoretically further changing the distribution and intensities of image pixels. Thereby, people who illegally obtain a document with this counterfeit protection mechanism have no knowledge of whether any counterfeit protection image is implemented. In other words, the original counterfeit protection image is displayed in the predetermined region only with the corresponding optical decoding piece, even if it has gone through the encoding of the second optical function and the optical curve body, because the optical functions of the decoding piece and the encoding optical function are mutually inverse, indicative that any given encoded (post-encoding) counterfeit protection image will be restored back into its original form as it is viewed through the optical decoding piece. If the original counterfeit protection image is displayed in the predetermined region of the document, the genuineness of this document is confirmed. In some cases, the use of the optical decoding piece requires some skill, such as not only placing the optical decoding piece at the predetermined region of the document, but also taking advantage of a predetermined side of the optical decoding piece with a predetermined angle, in order to have the original counterfeit protection image be appropriately displayed.

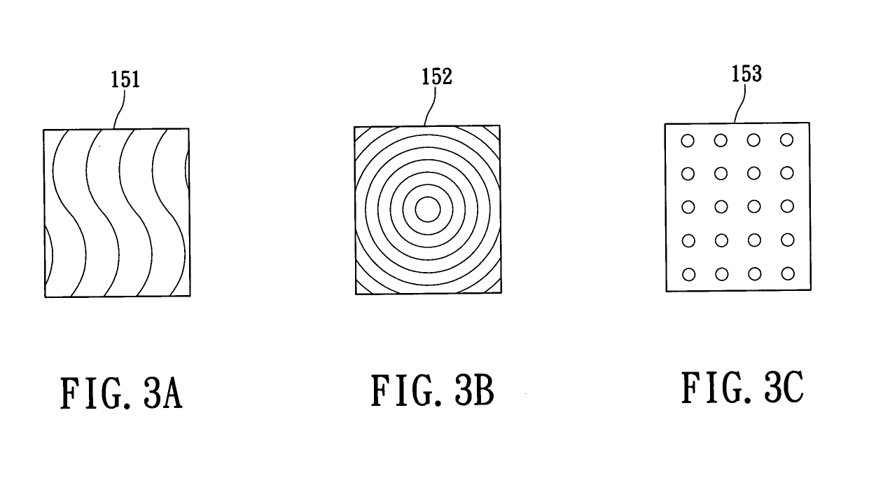

Reference is made to FIGS. 3A to 3C of schematic diagrams showing the marking distribution of the optical decoding piece. The marking distribution of the optical decoding piece is in a spiral, a concentric, and a multi-circular pattern. The marking distribution of the optical decoding piece is a combination of two or three of the above distribution pattern, and different marking distributions no doubt will affect the corresponding form of the first optical function thereof. Still, the optical decoding piece is also of a phase-type or an amplitude-type of decoding piece. From the standpoint of ordinary skilled people in this art, definitions of the phase and amplitude-type decoding pieces should be well known, and thus, the corresponding introduction to these different types of optical decoding piece is omitted from this specification. With aforementioned possible variations of the marking distribution, even if the optical decoding piece is picked up by someone else, the first optical function thereof is very difficult to derive, meaning the inverse function of the first optical function (second optical function) is consequently difficult to figure out, as well.

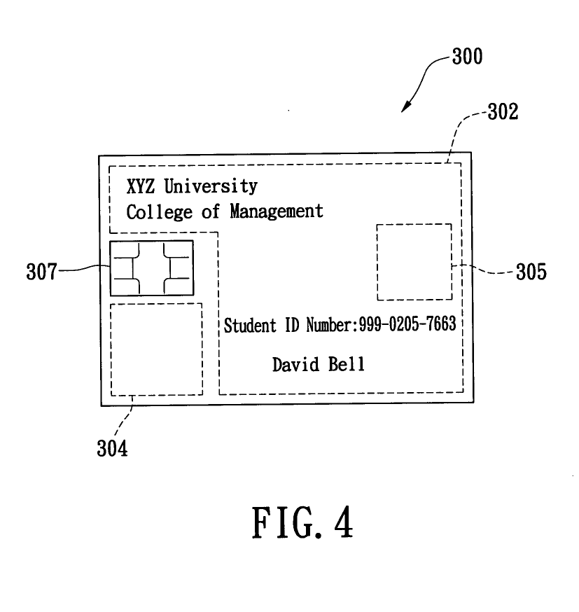

Reference is made to FIG. 4, which is a schematic diagram of showing a document 300 with the counterfeit protection mechanism based on the present invention. This document, preferably, is a student identification card having an optical curve body and a base monolithically formed together with the optical curve body. The optical curve body and the base form the one-piece main body of the document. This document 300 includes a major image (region) 302 and a counterfeit protection image (region) 304. Please note that the major image and the counterfeit protection image in many cases are not limited to corresponding image areas such as 302 and 304; in other words, the counterfeit protection image may be located within the area of the major image region 302.

The major image region 302 is the text of the document 300 and general image display such as a photo 305 is placed therein, as the counterfeit protection region 304 is for accommodating the corresponding counterfeit protection image. Besides, the document 300 further incorporates an IC chip 307 for data reading/writing after the cardholder identification has been identified. As the result of having the optical decoding piece applied to search for the counterfeit protection image, the original counterfeit protection image is supposed to be encoded by the inverse optical function of the corresponding equivalent optical function of the optical decoding piece in advance, and then converted by the corresponding optical function of the optical curve body. Preferably, the original counterfeit protection image will be in a visually unrecognizable state in the wake of being encoded by the inverse function of the optical decoding piece. Therefore, the counterfeit protection image is not displayed if no optical decoding piece associated with the present document is used, or the optical decoding piece is used but not placed in the predetermined region with a predetermined side thereof or looked through from a predetermined angle. Meanwhile, the major image is displayed normally, i.e., is visually recognizable, even it is placed under the optical curve body also and viewed through the optical decoding piece.

The use of optical curve body serves to protect the counterfeit protection image from being reproduced with commonly used scanning tools. Additionally, having the major document image and the counterfeit protection image placed under the optical curve body equivalently takes advantage of the optical curve body with its own respective optical function in addition to the optical encoding function, which is for generating a post-encoding counterfeit protection image. The post-encoding image is not visually recognizable without the use of the optical decoding piece. The optical encoding function and the optical function of the optical curve body are mutually matched. Because the optical encoding function (the second optical function) is an inverse optical function of the first optical function based on the marking distribution of the optical decoding piece, as long as the first optical function is complete, the second optical function is accordingly derived. Meanwhile, because the second optical function and the third optical function (i.e., the respective optical function of the optical curve body) are mutually matched, characteristics of the optical curve body are determined as well.

The optical curve body shown in FIG. 4 is a semi-cylindrical lens array. However, the optical curve body in FIG. 4 is just a preferred embodiment. Another embodiment such as a cylindrical lens array, a spherical lens array, or a hemispherical lens array is also applicable to the present invention. Besides, the curvature of the optical curve body may vary uniformly or non-uniformly, leading to variation of the optical function thereof. Most important of all, the optical curve body in the present invention serves as a doorkeeper to prevent the counterfeit protection image from being copied with ease, then imposes no negative effect on visual recognition of the major image and is mutually matched with the optical encoding function.

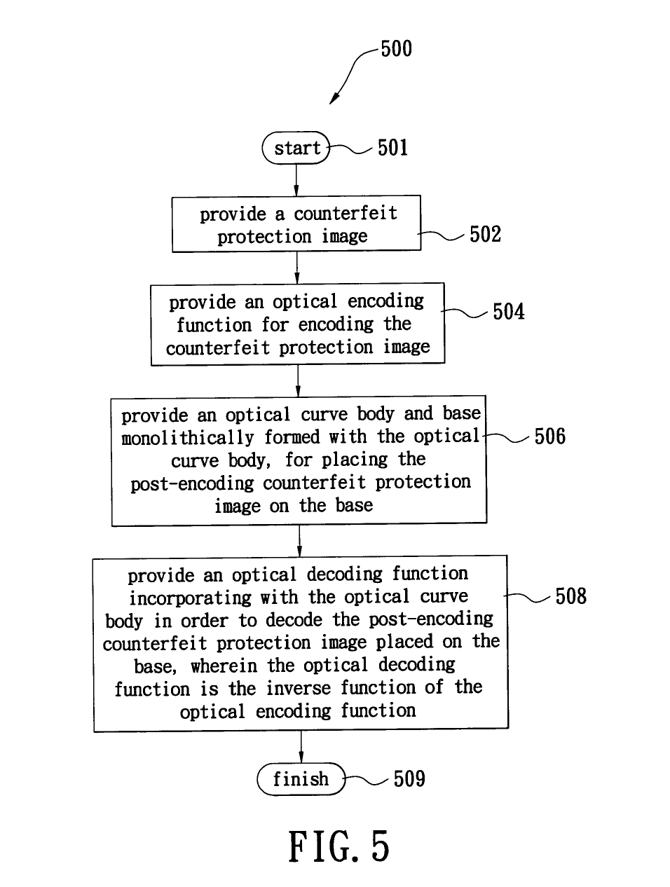

Reference is made to FIG. 5 of a simplified flow chart showing a document counterfeit protection mechanism 500 according to the present invention. The document counterfeit protection mechanism 500 includes steps as follows:
Step 501: start;
Step 502: provide a counterfeit protection image;
Step 504: provide an optical encoding function for encoding the counterfeit protection image;
Step 506: provide an optical curve body and base monolithically formed with the optical curve body, for placing the post-encoding counterfeit protection image on the base;
Step 508: provide an optical decoding function incorporating with the optical curve body in order to decode the post-encoding counterfeit protection image placed on the base, wherein the optical decoding function is the inverse function of the optical encoding function; and
Step 509: finish.

The document counterfeit protection mechanism 500 further includes a step of providing an optical decoding piece having the optical function thereof equivalent to the optical decoding function. The original counterfeit protection image is distributed over a predetermined region of the base after being encoded by the optical encoding function. Therefore, the post-encoding counterfeit protection image is restored only when the optical decoding piece placed on the predetermined region with a predetermined side thereof and a predetermined angle. In other words, the original counterfeit protection image is displayed only with the use of the optical decoding piece, provided the original counterfeit protection image equivalently goes through the processing of optical encoding function and the respective optical function of the optical curve body, both of which are mutually matched. Meanwhile, the major document image is placed on the base.

Simply speaking, the counterfeit protection image is processed through the optical encoding function and the respective optical function of the optical curve body and then distributed over the predetermined region of the base of the one-piece main body of the document consisting of the monolithically formed optical curve body and the base placed beneath. The optical encoding function and the respective optical function of the optical decoding piece are inverse functions of each other, therefore the post-encoding counterfeit protection image will be restored to the original counterpart thereof when the optical decoding piece is placed around the predetermined region of the base, with the predetermined side and the predetermined viewing angle. Thereby, the genuineness of the document will be confirmed if the counterfeit protection image is displayed in the predetermined region, as the document is further viewed through the optical decoding piece. Additionally, other than the counterfeit protection image, the major document image is still visually recognizable even if the major document image is viewed through the optical curve body

In summary, the present invention counterfeit protection mechanism further employs an optical curve body under which the major document image and the counterfeit protection image are placed. When no optical decoding piece is used, only the major document image is visible, meaning the genuineness of this document is unconfirmed and the counterfeit protection image cannot be easily copied because it is invisible. The genuineness of this document is confirmed when the optical decoding piece is placed over the predetermined region with the predetermined side thereof and the predetermined angle and the counterfeit protection image is made visible. As mentioned before, the counterfeit protection image is invisible without the optical decoding piece, and counterfeiters are thus are unable to copy the counterfeit protection image. Even in the worst scenario where a counterfeiter obtains an optical decoding piece having a respective optical decoding function and then perceives the original counterfeit protection image, because of the non-planar optical curve body, copying the original counterfeit protection image placed under the optical curve body is not easy, making counterfeiting difficult.

Those skilled in the art will readily observe that numerous modifications and alterations of the device may be made while retaining the teachings of the invention. Accordingly, the above disclosure should be construed as limited only by the metes and bounds of the appended claims.

1. A document counterfeit mechanism, a document including a major document image and a counterfeit protection image, comprising:
providing an optical curve body and a base disposed under the optical curve body in order to form a one-piece main body of the document, wherein the major document image is placed on the base;
providing an optical decoding piece substantially equivalent to a first optical function for confirming the genuineness of the document when the counterfeit protection image has been viewed through the incorporation of the optical curve body and the optical decoding piece;
deriving a second optical function from the first optical function, wherein the second optical function is an inverse function of the first optical function;
processing the counterfeit protection image through the second optical function in order to generate a corresponding post-encoding counterfeit protection image; and
placing the post-encoding counterfeit protection image on the base, wherein the counterfeit protection image is viewed through use of the optical decoding piece.

2. The document anti-counterfeiting mechanism of claim 1, further comprising a step of placing the post-encoding counterfeit protection image on a predetermined region of the base, wherein when the optical decoding piece is placed on the predetermined region, the counterfeit protection image is visible.

3. The document anti-counterfeiting mechanism of claim 2, further comprising a step of employing the optical decoding piece with a predetermined side thereof and a predetermined angle while viewing, wherein when the optical decoding piece has been placed on the predetermined region the counterfeit protection image is visible.

4. The document anti-counterfeiting mechanism of claim 1, further comprising a step of providing the optical curve body substantially equivalent to a third optical function.

5. The document anti-counterfeiting mechanism of claim 4, further comprising a step of having the major document image still in a visually recognizable state after being converted by the third optical function.

6. The document anti-counterfeiting mechanism of claim 4, wherein the counterfeit protection image converted by the second and the third optical functions is only visible through further use of the optical decoding piece.

7. The document anti-counterfeiting mechanism of claim 4, further comprising a step of matching the second optical function with the third optical function.

8. A counterfeit protection document comprising:
an optical curve body and a base located beneath the optical curve body, wherein the optical curve body and the base are monolithically formed;
a major document image placed on the base; and
a counterfeit protection image placed on a predetermined region of the base; wherein the counterfeit protection image is rendered visible in the predetermined region of the base by incorporation of an optical decoding piece.

9. The document of claim 8, wherein the counterfeit protection image placed on the predetermined region of the base is an outcome of processing an original counterfeit protection image by an inverse function of an equivalent optical function of the optical decoding piece.

10. The document of claim 8, wherein the major document image is still in a visually recognizable state when viewed through the optical curve body.

11. The document of claim 8, wherein a marking distribution of the optical decoding piece is in a spiral, a concentric, or a multi-circular pattern.

12. The document of claim 11, wherein a marking distribution of the optical decoding piece is a combinations of two or all three of the spiral, the concentric, and the multi-circular patterns.

13. The document of claim 8, wherein the optical decoding piece is of a phase-type or an amplitude-type optical decoding piece.

14. The document of claim 8, wherein the optical curve body is implemented with a semi-cylindrical lens array.

15. The document of claim 8, wherein the optical curve body is implemented with a cylindrical lens array.

16. The document of claim 8, wherein the curvature of the optical curve body is non-uniform.

17. The document of claim 8, wherein the optical curve body is implemented with a spherical lens array.

18. The document of claim 8, wherein the optical curve body is implemented with a hemispherical lens array.

19. A counterfeit protection document comprising:
an optical curve body and a base disposed beneath the optical curve body, wherein the optical curve body and the base are monolithically formed together; and
a counterfeit protection image placed in a predetermined region of the base;
wherein the counterfeit protection image is rendered visible in the predetermined region of the base through use of an optical decoding piece.

20. The document of claim 19, wherein the counterfeit protection image is the outcome of processing an original counterfeit protection image by an inverse function of an equivalent optical function of the optical decoding piece.

21. The document of claim 19, further comprising a major image, wherein the major image is still in a visually recognizable state when viewed through the optical curve body.

22. The document of claim 19, wherein a marking distribution of the optical decoding piece is a spiral, a concentric or a multi-circular pattern.

23. The document of claim 22, wherein the marking distribution of the optical decoding piece is combinations of two or three of the spiral, the concentric, and the multi-circular patterns.

24. The document of claim 19, wherein the optical decoding piece is of a phase-type or an amplitude-type optical decoding piece.

25. A document counterfeit protection mechanism comprising:
providing a counterfeit protection image;
providing an optical encoding function for encoding the counterfeit protection image;
providing an optical curve body and a base beneath the optical curve body, wherein the base and the optical curve body are monolithically formed together, distributing the encoded counterfeit protection image on the base; and
providing an optical decoding function incorporated with the optical curve body for decoding the encoded counterfeit protection image on the base, wherein the optical decoding function is an inverse function of the optical encoding function.

26. The mechanism of claim 25, further comprising a step of providing an optical decoding piece having an optical function substantially equivalent to the optical decoding function.

27. The mechanism of claim 26, further comprising a step of having the encoded counterfeit protection image placed on a predetermined region of the base, wherein the counterfeit protection image is rendered visible when the optical decoding piece is placed on the predetermined region.

28. The mechanism of claim 27, further comprising a step of employing the optical decoding piece with a predetermined side thereof and a predetermined angle, in order to discover the counterfeit protection image when the optical decoding piece is placed on the predetermined region.

29. The mechanism of claim 26, further comprising the counterfeit protection image being invisible without using the optical decoding piece after the counterfeit protection image is converted by the optical encoding function and an optical function of the optical curve body.

30. The mechanism of claim 25, further comprising the optical encoding function and the optical function of the optical curve body being mutually matched.

31. The mechanism of claim 25, further comprising a step of placing a major image on the base.
